(19) United States
(12) Patent Application Publication
(10) Pub. No.: US 2004/0186741 A1
(43) Pub. Date: Sep. 23, 2004

(54) Packaging system of rewritable paper, selling method thereof, and rewritable paper

(75) Inventor: Munenori Sawada, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/735,662

(22) Filed: Dec. 16, 2003

(30) Foreign Application Priority Data
Dec. 26, 2002 (JP) 2002-377292

(51) Int. Cl. G06F 17/60

(52) U.S. Cl. 705/1

(57) ABSTRACT

The invention makes effective use of features of rewritable paper when selling. A packaging system prints prescribed contents on a print face of rewritable paper in the leading portion in the form of sales, and then packages it. When a purchaser uses the rewritable paper in practice, he or she can print target information without any hindrance via rewriting which is a feature of the rewritable paper. It is therefore not necessary to present information that a distributor wants to present to a purchaser upon selling the rewritable paper by printing such information on a separate sheet or on the wrapping. This permits resource saving and enables a new sales form to be provided by effective use of the features of the rewritable paper.

### BACKGROUND OF THE INVENTION

1. Field of Invention

The present invention relates to a packaging system of rewritable paper permitting rewriting of printed information, a sales method thereof, and rewritable paper.

2. Description of Related Art

Related art rewritable paper permits a reversible change between a colored state and a non-colored state by utilizing heat, light or chemical reactions. For example, rewritable paper permitting a reversible change between the colored and non-colored states by heating it to different temperatures is disclosed in Japanese Unexamined Patent Application Publication No. 5-032045, for example.

Because of the possibility to rewrite, as required, once printed information, rewritable paper provides various advantages as compared with the paper media not permitting rewriting, such as ordinary printer paper.

### SUMMARY OF THE INVENTION

However, advantages of related art rewritable paper are substantially limited to those available when a user uses rewritable paper, i.e., when the user performs printing thereon.

On the other hand, since information once printed on rewritable paper can be rewritten, it is possible to adopt a sales form different from those for other paper media upon sale.

The present invention makes effective use of the favorable features of rewritable paper when selling rewritable paper.

To address or solve the above, the present invention provides a packaging system for packaging rewritable paper, including: a paper feeding device which supplies a prescribed number of sheets (one or more sheets) of rewritable paper to be packaged as one set; a contents adding device which adds prescribed contents (for example, an operation manual of a product, a calendar, or any of various other ones to achieve a purpose) to the one set of rewritable paper; and a packaging device which packages the one set of rewritable paper, in a state in which the contents have been added, into a prescribed form to be sold.

The above-mentioned contents adding device adds the prescribed contents to all or part of the one set of rewritable paper; and the above-mentioned packaging device accomplishes packaging into a prescribed form permitting visual recognition, from outside, of the fact that the prescribed contents have been added to all or part of the rewritable paper.

Being able to visually recognize, from outside, that the prescribed contents are added to all or part of the rewritable paper include that the added contents themselves are viewable from outside and the fact that the contents are added is viewable from outside.

The contents adding device adds prescribed contents to prescribed sheets of rewritable paper including at least a leading portion thereof (i.e., the sheet of rewritable paper whose print face is visible), and the packaging device packages the rewritable paper into a form permitting visual recognition of the contents in the leading portion from outside.

The content adding device prints the prescribed contents onto the prescribed sheets of rewritable paper from among the one set of rewritable paper fed from the paper feeding device.

The contents adding device inserts the rewritable paper having the prescribed contents printed thereon at a prescribed position of the one set of rewritable paper.

The contents adding device adds related information (for example, usage of the commercial product, explanation regarding the product, user's impression of use, or the like) directly associated with commercial sale of the rewritable paper.

The content adding device adds added-value information which provides added value (for example, advertising of a commercial product having no relationship with rewritable paper or a product related to rewritable paper, a beginning portion of a cartoon or a novel, a part of a book, fortune-telling, a quiz, a senryu (a seventeen-syllable poem which is often satirical of the times), or a cooking recipe) when commercially selling the rewritable paper.

Another exemplary embodiment further includes a contents supplying device which supplies contents to be added by the contents adding device, and the contents added by the contents adding device are changeable to different contents supplied by the contents supplying device.

A still another exemplary embodiment further includes a contents specifying device to specify the contents to be added by the contents adding device.

The present invention further provides a sales method for commercially selling rewritable paper, including: printing prescribed contents to be added in advance on the rewritable paper in an initial sales stage (i.e., a state at a point of time when the rewritable paper is sold to distributors and to purchasers including final consumers) onto the rewritable paper to be added, the printed contents being erasable in practical use.

An exemplary embodiment of the sales method of rewritable paper of the present invention further includes: selling a prescribed number of sheets of the rewritable paper as one set; printing in advance the prescribed contents on all or part of the rewritable paper; and selling the rewritable paper by packaging into a form permitting Visual recognition, from outside, of the fact that the prescribed contents are printed on all or part of the rewritable paper.

Another exemplary embodiment of the sales method further includes: printing in advance the prescribed contents onto prescribed rewritable paper including at least the leading portion of the one set of rewritable paper, and selling the rewritable paper by packaging into the prescribed form permitting visual recognition, from outside, of the contents in the leading portion.

In still another exemplary embodiment, the prescribed contents are related information directly associated with commercial sale of the rewritable paper.

In another exemplary embodiment, the prescribed contents are added-value information which provides added value when commercially selling the rewritable paper.

Another exemplary embodiment of the sales method of rewritable paper of the present invention further includes: receiving specification of the prescribed contents which a purchaser of the rewritable paper demands printing, and selling the rewritable paper having the specified contents printed thereon.

The present invention also provides rewritable paper in a ready-to-sell state, including a sheet on which prescribed contents are previously printed in an initial sales stage, the contents being erasable when the purchaser uses the rewritable paper.

In an exemplary embodiment of the rewritable paper of the present invention, a prescribed number of sheets is treated as one set when selling the rewritable paper; the prescribed contents are printed onto all or part of that one set of rewritable paper; and the set of rewritable paper is packaged into a prescribed form permitting visual recognition, from outside, of the fact that the prescribed contents are printed on all or part of rewritable paper.

In another exemplary embodiment of the rewritable paper, the prescribed contents are printed on the leading portion of the one set of rewritable paper, and the one set of rewritable paper is packaged in a form permitting visual recognition, from outside, of the contents.

In still another exemplary embodiment of the rewritable paper, the prescribed contents are related information directly associated with commercial sale of the rewritable paper.

In another exemplary embodiment of the rewritable paper, the prescribed contents are added value information which provides added value when commercially selling the rewritable paper.

According to the present invention, prescribed contents are added to a set of rewritable paper in a form for sales, before packaging.

When the purchaser uses the rewritable paper, the purchaser can print information that he or she wants to without any hindrance through rewriting, which is an exemplary feature of the rewritable paper of the present invention.

Accordingly, when selling rewritable paper, it is therefore not necessary for the seller to present information which he or she wants to present to a purchaser in a form printed on a separate sheet or on a wrapping. It is thus possible to save resources, as well as to achieve effective use of the favorable features of rewritable paper, thereby providing a new sales form.

### BRIEF DESCRIPTION OF THE DRAWINGS

FIG. 1 is a schematic illustrating the configuration of the packaging system 1 of an exemplary embodiment;

FIG. 2 is a flowchart illustrating the packaging operation of the packaging system 1;

FIG. 3 is a schematic that illustrates an exemplary packaging form permitting visual recognition from outside of the contents printed on a sheet of rewritable paper in the leading portion;

FIG. 4 is a schematic that illustrates an exemplary packaging system 1 having a contents server 40 storing contents.

### DETAILED DESCRIPTION OF PREFERRED EMBODIMENTS

Exemplary embodiments of the packaging system of the present invention are described below with reference to the drawings.

An exemplary configuration is described below.

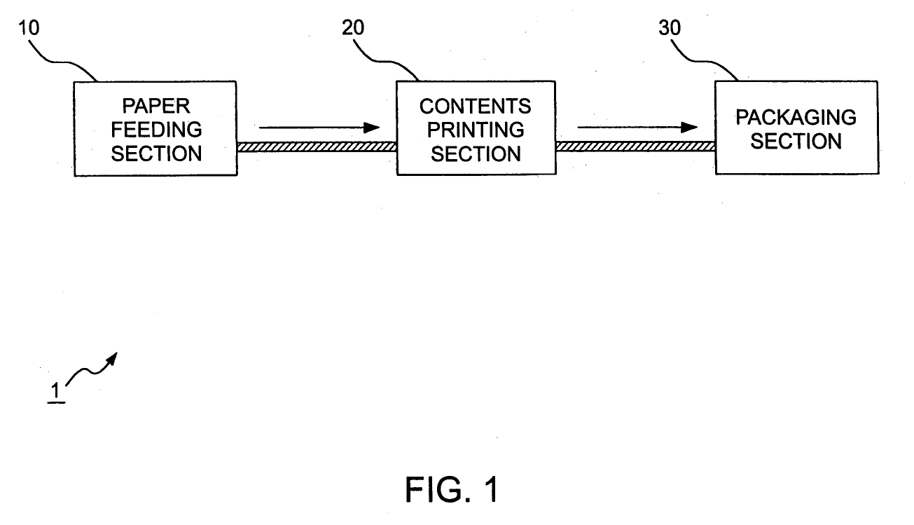

FIG. 1 is a schematic illustrating an exemplary configuration of a packaging system 1 of an exemplary embodiment.

In FIG. 1, the packaging system 1 includes a paper feeding section 10, a contents printing section 20, and a packaging section 30. In this configuration of the packaging system 1, rewritable paper to be packaged is conveyed by a conveying mechanism, such as a belt conveyor, from the paper feeding section 10, via the contents printing section 20, to the packaging section 30.

The paper feeding section 10 stores sheets of rewritable paper to become a product in a pre-packaging state, and delivers a prescribed number of sheets of rewritable paper (hereinafter “paper bundle”) forming a packaging unit sequentially to the contents printing section 20.

The contents printing section 20 prints prescribed contents on the leading portion (the sheet of rewritable paper having an exposed surface to be printed) out of the prescribed number of sheets of rewritable paper received from the paper feeding section 10.

As contents printed by the contents printing section 20, an operation manual of a product, a calendar or any of various others may be adopted according to the purpose of use.

The packaging section 30 packages a paper bundle including the rewritable paper having the contents printed thereon by the contents printing section 20 into a prescribed form.

In this process, the paper bundle is packaged into a form permitting visual recognition, from outside, of the printed contents having been printed on the rewritable paper.

Various such forms are conceivable. For example, it is possible to package the paper bundle with a vinyl bag having a transparent side at least on the print surface side.

The paper bundle packaged by the packaging section 30 is shipped as a product and displayed in the shop window. At that time, the contents printed on the rewritable paper catch purchasers' attention.

Examples of the contents printed by the contents printing section 20 are described below.

Even when a distributor prints information on the rewritable paper, such as for commercial goods, purchasers can use the paper by erasing the thus printed contents.

As a result, it becomes possible to print, directly on the rewritable paper, such as for a commercial product, the contents otherwise printed on a separate sheet when selling printing paper or the like.

More specifically, usage of a product, explanation of a product, user's impressions of use and the like can be printed.

When printing such information, it is possible to avoid circumstances in which a sheet containing the description of usage or the like printed thereon becomes finally unnecessary and is disposed, thus achieving resource saving.

It is also possible to print advertising of a product having no relationship with the rewritable paper or products related to the rewritable paper, a beginning portion of a cartoon or a novel, a part of a book, fortune-telling, a quiz, a senryu, a cooking recipe or the like.

When printing such information, information having a high added value for a purchaser can be contained in a commercial product upon selling the rewritable paper, thus permitting stimulation of purchaser's buying intention. Also, since even the sheet of rewritable paper having this information printed thereon is usable by the purchaser, resource saving can be attempted or achieved.

Furthermore, by printing the beginning portion of a cartoon or a novel, a purchaser's desire to read the following portions of the cartoon or the like is created, and this may lead to actual purchase thereof. Thus, a kind of advertising effect can be achieved.

An exemplary operation is described below.

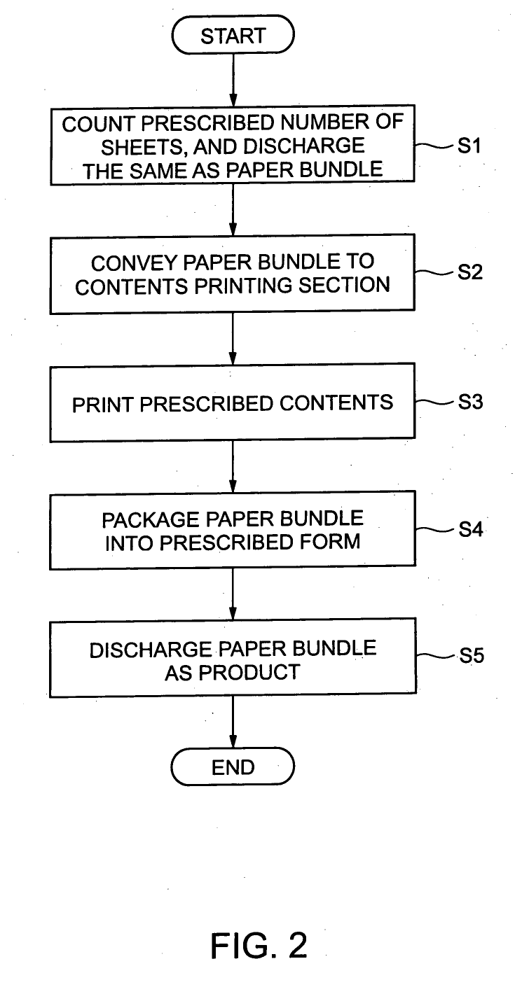

FIG. 2 is a flowchart illustrating the packaging operation of the packaging system 1.

In FIG. 2, when operation of the packaging system 1 is started, the paper feeding section 10 counts a prescribed number of sheets of the stored rewritable paper, and discharges the counted sheets as a paper bundle (step S1).

Then, the conveying mechanism conveys the paper bundle to the contents printing section 20 (step S2).

Then, the contents printing section 20 prints the prescribed contents onto the print surface of the sheet of rewritable paper at the leading portion of the conveyed paper bundle (step S3).

Then, the paper bundle is conveyed from the contents printing section 20 to the packaging section 30 (step S4).

The packaging section 30 packages the paper bundle into a prescribed form (step S5), and discharges the paper bundle in the form of products at a point of accumulation of products (step S6).

When all the sheets of rewritable paper stored in the paper feeding section 10 are thus processed, the packaging system 1 completes the packaging operation.

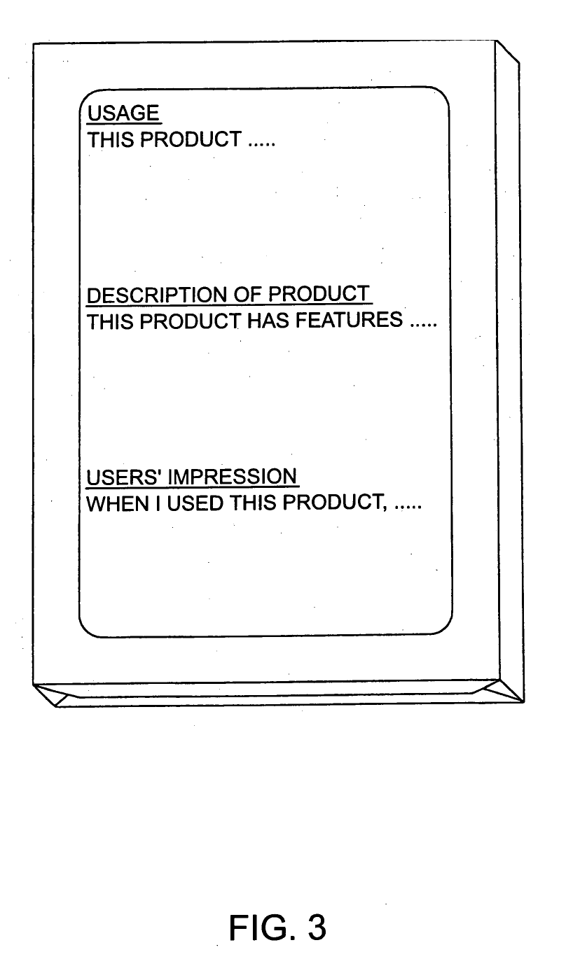

The paper bundle packaged by the packaging system 1 takes, for example, the form as shown in FIG. 3, permitting visual recognition, from outside, of the contents printed on the leading portion of the rewritable paper.

As a result, when the rewritable paper is displayed in the shop window for sales, the contents permit expectation of effects, such as achievement of an advertising function, stimulation of a purchasers' buying intention, and discrimination from other products of similar types.

On the other hand, because the purchaser can reuse the rewritable paper having the contents printed thereon by erasing the printed contents, the number of sheets of rewritable paper usable by the purchaser is never reduced.

As described above, the packaging system 1 of this exemplary embodiment packages the rewritable paper after printing the prescribed contents onto the print face of the rewritable paper in the leading portion in the form for sales.

When the purchaser employs the rewritable paper, information which he or she wants to print can be printed without any hindrance through rewriting, which is a feature of the rewritable paper.

It is not therefore necessary to present information that the seller wishes to present to the purchasers upon selling the rewritable paper through printing on a separate sheet or a wrapping. This permits resource saving and a new sales form to be provided through utilization of the features of the rewritable paper.

Exemplary embodiments of sales of rewritable paper other than this exemplary embodiment are executable.

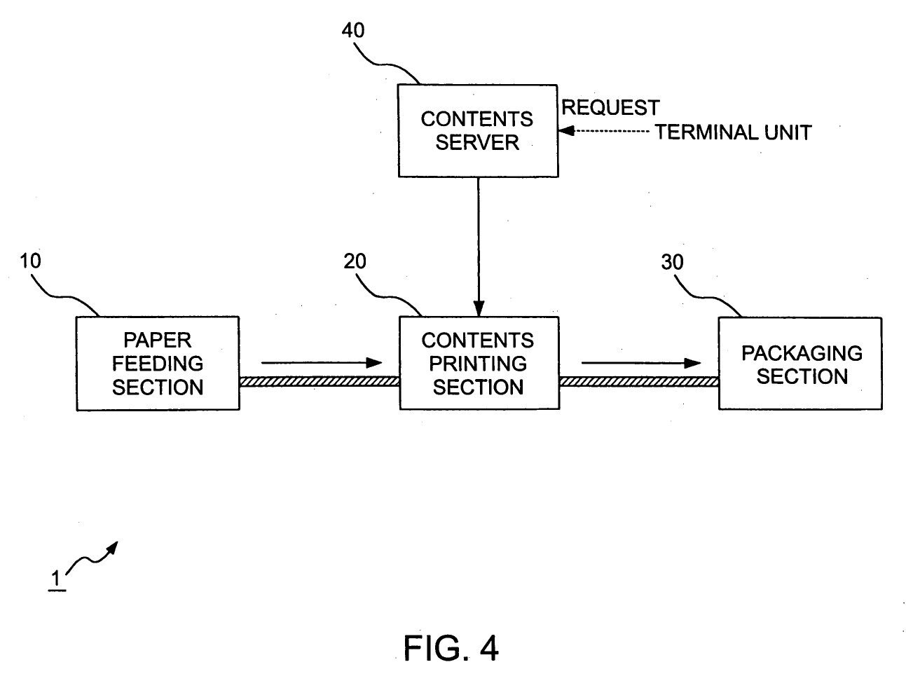

For example, as shown in FIG. 4, the packaging system 1 may further include a contents server 40 to store the contents so that the contents server 40 suitably provides contents to be printed to the contents printing section 20.

Adoption of this configuration makes it possible to easily modify contents to be printed for each paper bundle, and to set a printing program of contents in detail.

In the system shown in FIG. 4, furthermore, a terminal unit connected to the contents server 40 may be provided so that the distributor or the purchaser can request the contents to be previously printed in this configuration.

The paper bundle having the contents requested through a terminal unit printed thereon is shipped to the distributor or purchaser who made the request.

When a distributor makes a request, the paper bundle onto which the contents that the distributor considers to have a larger sales promoting effect are printed is delivered. When the bundles are displayed in the shop window, the sales would be actually better, and this increases the distributor's motivation to purchase rewritable paper packaged by the system shown in FIG. 4. That is, the increase in the number of rewritable paper sheets delivered to distributors results in promotion of sales of rewritable paper packaged by the system shown in FIG. 4.

Furthermore, when the purchaser makes a request, the purchaser can simultaneously obtain the requested contents and the rewritable paper. This arouses a purchaser's buying intention, thus directly promoting sales of rewritable paper packaged by the system shown in FIG. 4.

In this exemplary embodiment, the above description is based on a configuration in which the contents printing section 20 prints the contents on rewritable paper positioned in the leading portion of the paper bundle. In the place of printing the contents, rewritable paper having the already printed contents may be added to the leading portion of the paper bundle.

More specifically, rewritable paper having the contents printed thereon is stored, and a contents paper feeding section which adds the printed rewritable paper to the leading portion of the paper bundle upon packaging may be provided in place of the contents printing section 20.

Such a configuration provides advantages, including a more rapid packaging operation, for example.

This exemplary embodiment is described above on the assumption that contents are printed only on the rewritable paper positioned in the leading portion of the paper bundle. The advantages of the present invention are also available by printing the contents on the rewritable paper in a portion other than the leading portion of the paper bundle.

For example, by previously printing the details of the contents printed on other sheets of rewritable paper on the sheet of rewritable paper in the leading portion as a caption, the purchaser can recognize the details of the contents, and fully utilize the effects of selling the rewritable paper by printing in advance the contents on the rewritable paper.

Another feature of the rewritable paper is that a sheet of rewritable paper has a print surface (face side) and a back side, and mistaking one for the other leads to impossibility to print.

In order to clearly show to the user which is the face side, therefore, it is also possible to print in advance information showing the face side, such as a message “Face Side,” or the maker name, on the face side.

By previously printing a favorable result of a lottery, such as “Winning” on randomly selected sheets of rewritable paper, it is possible to give a certain privilege to the purchaser of a paper bundle including such sheets of rewritable paper.

The distributor may print the contents in the shop upon sales, apart from the case of printing the contents upon packaging, as described in this exemplary embodiment.

In this case, contents accurately suitable to the timing of purchase (such as the newspaper of the day or the calendar of the month) may be printed, thereby further enhancing the sales promoting effect.

It is also possible to sell a plurality of sheets of rewritable paper in a lump as a paper bundle, or sell by the sheet.

When selling rewritable paper by the sheet, the advantage of printing contents in the store is more effective.

What is claimed is:

1. A packaging system for packaging rewritable paper, comprising:
a paper feeding device which supplies a prescribed number of sheets of rewritable paper to be packaged as one set;
a contents adding device which adds prescribed contents to the one set of rewritable paper; and
a packaging device which packages the one set of rewritable paper, in a state in which the contents have been added, into a prescribed form to be sold.

2. The packaging system according to claim 1,
the contents adding device adding the prescribed contents to all or part of the one set of rewritable paper; and
the packaging device accomplishing packaging into a prescribed form permitting visual recognition from outside of the fact that the prescribed contents have been added to the all or part of the rewritable paper.

3. The packaging system according to claim 1,
the contents adding device adding the prescribed contents to prescribed sheets of the rewritable paper including at least a leading portion thereof; and
the packaging device packaging the rewritable paper into a form permitting visual recognition of the contents printed on the leading portion from outside.

4. The packaging system according to claim 1, the contents adding device printing the prescribed contents onto the prescribed sheets of the rewritable paper from among the one set of rewritable paper fed from the paper feeding device.

5. The packaging system according to claim 1, the contents adding device inserting the rewritable paper having the prescribed contents printed thereon at a prescribed position of the one set of rewritable paper.

6. The packaging system according to claim 1, the contents adding device adding related information directly associated with commercial sale of the rewritable paper.

7. The packaging system according to claim 1, the contents adding device adding added value information which provides added value when the rewritable paper is commercially sold.

8. The packaging system according to claim 1, further comprising a contents supplying device which supplies contents to be added by the contents adding device, and the contents added by the contents adding device being changeable to different contents supplied by the contents supplying device.

9. The packaging system according to claim 1, further comprising a contents specifying device to specify the contents to be added by the contents adding device.

10. A sales method for commercially selling rewritable paper, comprising:
printing prescribed contents to be added, in advance, onto the rewritable paper in an initial sales stage, the printed contents being erasable when the rewritable paper is actually used.

11. The sales method of rewritable paper according to claim 10, further comprising: selling a prescribed number of sheets of rewritable paper as one set; printing in advance the prescribed contents on all or part of the rewritable paper; and selling the rewritable paper by packaging into a form permitting visual recognition, from outside, of the fact that the prescribed contents are printed on all or part of the rewritable paper.

12. The sales method of rewritable paper according to claim 10, further comprising:
printing in advance the prescribed contents onto prescribed sheet of rewritable paper including at least the leading portion of the one set of rewritable paper, and selling the rewritable paper by packaging into a prescribed form permitting visual recognition, from outside, of the contents in the leading portion.

13. The sales method of rewritable paper according to claim 10, the prescribed contents being related information directly associated with commercial sale of the rewritable paper.

14. The sales method of rewritable paper according to claim 10, the prescribed contents being added-value information which provides added value when commercially selling the rewritable paper.

15. The sales method of rewritable paper according to claim 10, further comprising: receiving specification of the prescribed contents which a purchaser of the rewritable paper demands printing, and selling the rewritable paper having the specified contents printed thereon.

16. Rewritable paper prepared into a form for selling to a purchaser, comprising:
a sheet on which prescribed contents are printed in an initial sales stage, the contents being erasable when the purchaser uses the rewritable paper.

17. The rewritable paper according to claim 16, a prescribed number of sheets being treated as one set when selling the rewritable paper; prescribed contents being printed onto all or part of the one set of rewritable paper; and the set of rewritable paper being packaged into a prescribed form permitting visual recognition, from outside, of the fact that the prescribed contents are printed on the all or part of rewritable paper.

18. The rewritable paper according to claim 16, prescribed contents being printed on a leading portion of the one set of rewritable paper, and the one set of rewritable paper being packaged in a form permitting visual recognition, from outside, of the contents.

19. The rewritable paper according to claim 16, the prescribed contents being related information directly associated with commercial sale of the rewritable paper.

20. The rewritable paper according to claim 16, the prescribed contents being added-value information which provides added value when commercially selling the rewritable paper.
